(19) United States
(12) Patent Application Publication
(10) Pub. No.: US 2013/0135899 A1
(43) Pub. Date: May 30, 2013

(54) ELECTRONIC DEVICE

(71) Applicants: Mei-Hsiung Tsai, Taipei City (TW); Tien-Hung Hou, Taipei City (TW)

(72) Inventors: Mei-Hsiung Tsai, Taipei City (TW); Tien-Hung Hou, Taipei City (TW)

(21) Appl. No.: 13/655,462

(22) Filed: Oct. 19, 2012

Related U.S. Application Data
(60) Provisional application No. 61/563,824, filed on Nov. 27, 2011.

(51) Int. Cl. G09F 13/04; F21V 7/00; F21V 8/00

(52) U.S. Cl. CPC G09F 13/04; G02B 6/0001; F21V 7/0066
USPC 362/609; 362/97.1; 362/611

(57) ABSTRACT

An electronic device including a display is provided. The display is disposed above a being illuminated surface to illuminate the being illuminated surface. The display has a first light exiting area and a second light exiting area, wherein illumination of the being illuminated surface contributed by the first light exiting area is smaller than illumination of the being illuminated surface contributed by the second light exiting area.

### CROSS-REFERENCE TO RELATED APPLICATION

This application claims the priority benefits of U.S. provisional application Ser. No. 61/563,824, filed on Nov. 27, 2011. The entirety of the above-mentioned patent application is hereby incorporated by reference herein and made a part of this specification.

### BACKGROUND OF THE INVENTION

1. Field of the Invention

The invention is related to an electronic device.

2. Description of Related Art

In general, an electronic device (for example, a notebook computer) includes a display and a base. The base includes a keyboard for the notebook computer, wherein the keyboard is usually illuminated by an external light source in order for a user to recognize a word on the keyboard and a position of a key. In order for the user to recognize the key to operate in a dark environment, a conventional technique is to dispose a backlight source, for example, a backlight source using light emitting diode, under the keyboard.

The light emitted from the backlight source radiates the base of the keyboard upwardly and transmitted through a transparent symbol or word on the keyboard. Therefore, the user is able to recognize the key to operate in a dark environment. Since this method requires disposing an additional backlight source under the keyboard, the manufacturing cost of the electronic device is increased, and the power consumption of the electronic device is also increased. In addition, a thickness of the keyboard is often increased when adding the backlight source. Therefore, how to maintain the thickness of the keyboard (or an overall thickness of the electronic device) while allowing the user to recognize the key to operate in a dark environment is an issue that research and development engineers anxiously want to solve.

### SUMMARY OF THE INVENTION

The invention provides an electronic device that is capable of improving an operational accuracy and convenience in a dark environment and maintaining a low manufacturing cost and low power consumption at the same time.

An electronic device including a display is provided. The display is disposed above a being illuminated surface to illuminate the being illuminated surface. The display has a first light exiting area and a second light exiting area, wherein illumination of the being illuminated surface contributed by the first light exiting area is smaller than illumination of the being illuminated surface contributed by the second light exiting area.

In an embodiment of the invention, the display further includes a display panel and a backlight module. A backlight module is disposed on a side of the display panel, wherein the backlight module includes a horizontal prism sheet. The horizontal prism sheet includes a first area and a second area, wherein the first area is disposed correspondingly with the first light existing area of the display, and the second area is disposed correspondingly with the second light existing area of the display. The first area has a plurality of first prisms, and the second area has a plurality of second prisms, wherein a vertex angle of the second prism is smaller than a vertex angle of the first prism.

In an embodiment of the invention, the being illuminated surface is a surface of a base. The base is connected to a side of the display, and the second area of the horizontal prism sheet is disposed adjacently to the base.

In an embodiment of the invention, the vertex angle of the second prism is greater than or equal to 80 degrees but less than 90 degrees.

In an embodiment of the invention, the vertex angle of the second prism is greater than or equal to 82 degrees but smaller than or equal to 88 degrees.

In an embodiment of the invention, the vertex angle of the first prism is substantially equal to 90 degrees.

In an embodiment of the invention, each of the first prisms and the second prisms has two base angles that are substantially equal to each other.

In an embodiment of the invention, an area of the second area occupies ½ to ⅓ of an entire area of the horizontal prism sheet.

In an embodiment of the invention, the second area includes a plurality of sub-regions, and the vertex angles of the second prisms in the sub-regions diminish from the sub-region near the first area to the sub-region distant from the first area.

In an embodiment of the invention, the backlight module further includes a backlight source, wherein the horizontal prism sheet is disposed between the backlight source and the display panel.

In an embodiment of the invention, the backlight source includes a light guide plate and a light emitting device, which is disposed beside the light guide plate. In an embodiment of the invention, the backlight source further includes a reflector, which is disposed on a side of the light guide plate opposite to the horizontal prism sheet.

In an embodiment of the invention, the backlight module further includes a vertical prism sheet, which is disposed between the backlight source and the horizontal prism sheet.

In an embodiment of the invention, the vertical prism sheet includes a plurality of vertically aligned third prisms.

As described above, part of the light from the second light existing area of the display panel is deflected with a large angle to irradiate the being illuminated surface by designing the vertex angle of the second prism to be smaller than 90 degrees in the embodiment of the invention. Therefore, the additional backlight source is not needed to be disposed under the being illuminated surface (which is the surface of the base adjacent to the display panel). The user is able to recognize each keys and operate in a dark environment. Thus, the operational accuracy and the convenience to work in a dark environment are improved. In addition, since the backlight source under the base is not adopted, and the being illuminated surface is irradiated by the light from the display, the electronic device of the invention is able to maintain the low manufacturing cost and power consumption and able to have a relatively thin base.

In order to make the aforementioned features and advantages of the invention more comprehensible, embodiments accompanying figures are described in details below.

### BRIEF DESCRIPTION OF THE DRAWINGS

FIGS. 1A and 1B are schematic side views of an electronic device according to an embodiment of the invention.

FIGS. 2A-2C are cross-sectional views schematically illustrating a horizontal prism sheet of a backlight module in FIG. 1A or FIG. 1B according to a different embodiment of the invention.

FIG. 3 is a schematic view of a backlight module and a display panel in FIGS. 1A and 1B.

FIG. 4 is a relationship diagram of a light emitting angle and a light emitting ratio measured under different vertex angles.

### DESCRIPTION OF EMBODIMENTS

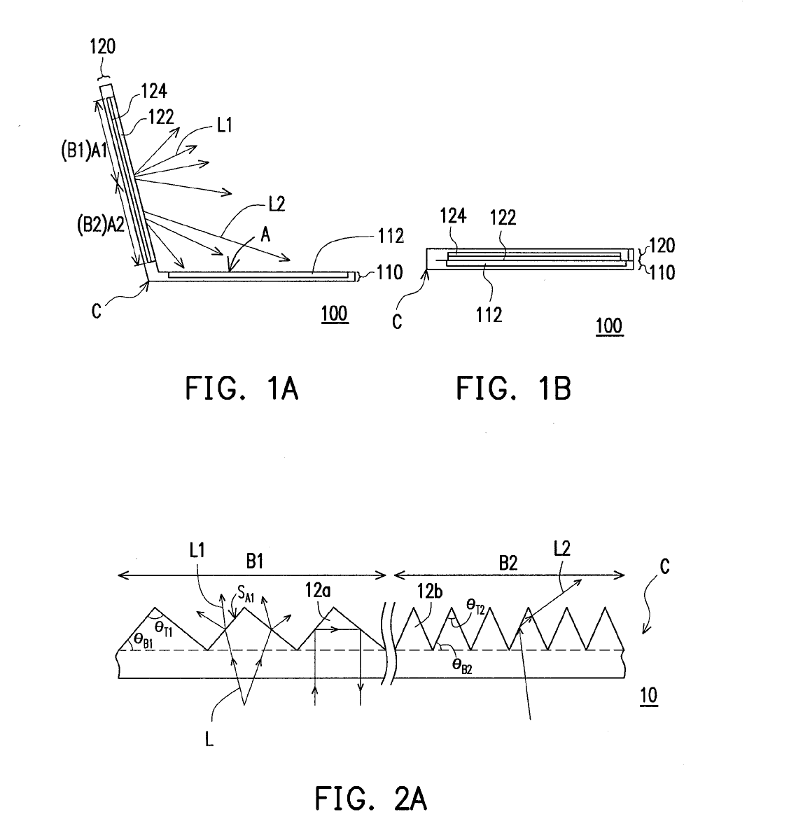

FIGS. 1A and 1B are schematic side views of an electronic device according to an embodiment of the invention. Referring to FIGS. 1A and 1B, the electronic device 100 of the present embodiment includes a display 120, which is disposed above the being illuminated surface A to illuminate the being illuminated surface A. Furthermore, the display 120 has a first light exiting area A1 and a second light exiting area A2, wherein illumination of the being illuminated surface A contributed by the first light exiting area A1 is smaller than illumination of the being illuminated surface A contributed by the second light exiting area A2. The electronic device 100 of the present embodiment is, for example, a notebook computer, but the invention is not limited thereto. In addition, the display 120 is rotatably connected to a base 110, and the electronic device 100 is in a folded state (as the state illustrated in FIG. 1B) and an unfolded state (as the state illustrated in FIG. 1A) by rotating the display 120 relatively to the base 110.

Specifically, the display 120, for example, uses a connection part C of the base 110 and the display 120 as an axis of rotation to rotate relatively to the base 110. When the display 120 rotates in a direction away from the base 110, the electronic device 100 is in the unfolded state as shown in FIG. 1A. When the display 120 rotates in a direction close to the base 110, the electronic device 100 is in the folded state as shown in FIG. 1B.

In the present embodiment, the being illuminated surface A is, for example, a surface of the base 110, wherein the base 110 is connected to a side of the display 120. The being illuminated surface A may be a surface of an input interface 112. In the present embodiment, the input interface 112 is, for example, a keyboard, but the invention is not limited thereto.

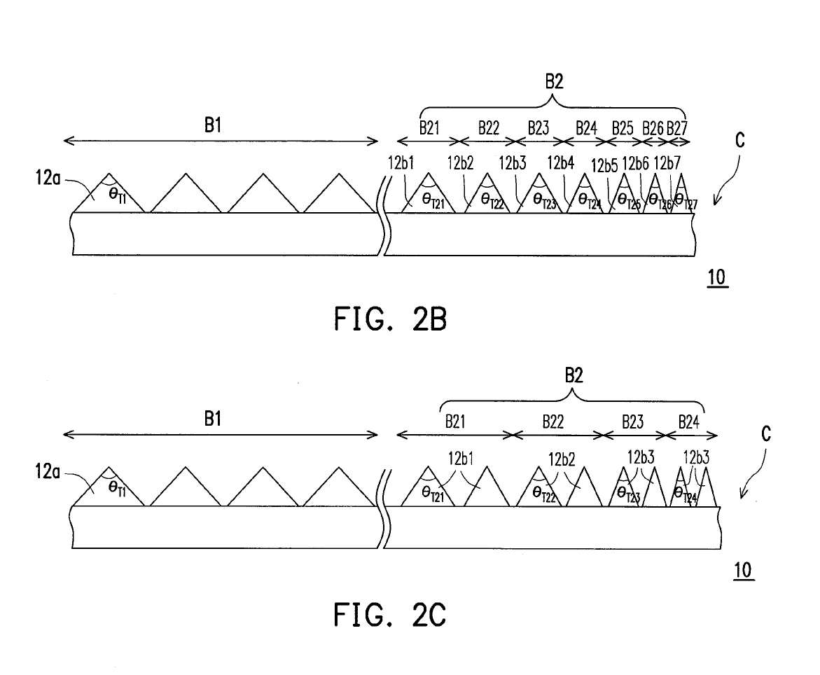

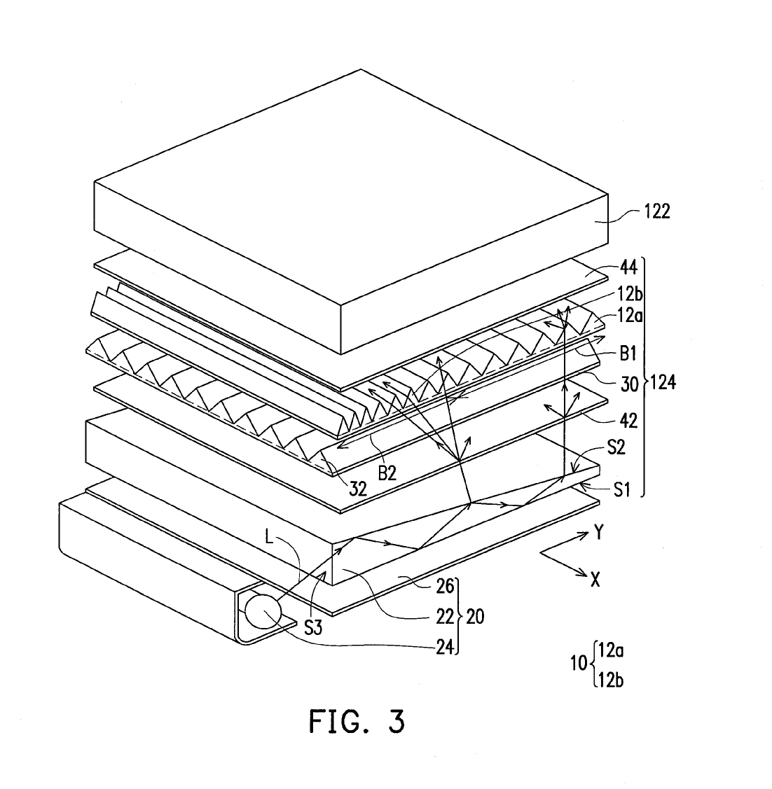

The display 120 includes a display panel 122 and a backlight module 124 disposed on a side of the display panel 122. Specifically, when the electronic device 100 is in the folded state (as illustrated in FIG. 1B), the backlight module 124 is disposed on a side relatively away from the base 110 of the display panel 122. Moreover, the backlight module 124 includes a horizontal prism sheet 10 (as illustrated in FIGS. 2A and 3), wherein a vertex angle of the horizontal prism sheet 10 points at the display panel 122.

Referring to FIGS. 2A-2C, the horizontal prism sheet is further described hereinafter. FIGS. 2A-2C are cross-sectional views schematically illustrating a horizontal prism sheet of a backlight module in FIG. 1A or FIG. 1B according to a different embodiment of the invention. Referring to FIGS. 1A and 2A, the horizontal prism sheet 10 of the backlight module 124 of the present embodiment includes a first area B1 and a second area B2, wherein the first area B1 is disposed corresponding to the first light existing area A1 of the display 120, and the second area B2 is disposed corresponding to the second light existing area A2 of the display 120. Furthermore, the second area B2 of the horizontal prism sheet 10 is disposed adjacent to the base 110. The first area B1 has a plurality of first prisms 12a, and the second area B2 has a plurality of second prisms 12b. In the present embodiment, an area of the second area occupies ½ to ⅓ of an entire area of the horizontal prism sheet 10.

Furthermore, a vertex angle θ_{T2} of the second prism 12b is smaller than a vertex angle θ_{T1} of the first prism 12a. Specifically, the vertex angle θ_{T1} of the first prism 12a is substantially equal to 90 degrees, and the vertex angle θ_{T2} of the second prism 12b is less than 90 degrees. In detail, the vertex angle θ_{T2} of the second prisms 12b is greater than or equal to 80 degrees but smaller than 90 degrees. In the present embodiment, the vertex angle θ_{T2} of the second prism 12b is greater than or equal to 82 degrees but smaller than or equal to 88 degrees. In addition, each of the first prisms 12a and the second prisms 12b has two base angles that are substantially equal to each other (including θ_{B1} and θ_{B2}), but the invention is not limited thereto. Persons skilled in the art may adjust the base angles of each of the first prisms 12a and the second prisms 12b (including θ_{B1} and θ_{B2}) according to the design requirement of an actual product.

Referring to FIG. 2B, in this embodiment, the second area B2 of the horizontal prism sheet 10 may be further divided into a plurality of sub-regions B21, B22, B23, B24, B25, B26, and B27. These sub-regions, B21, B22, B23, B24, B25, B26, and B27, are arranged in sequence from the first area B1 to the connection part C of the display 120 and the base 110, wherein the vertex angles θ_{T21}, θ_{T22}, ƒ_{T23}, θ_{T24}, θ_{T25}, θ_{T26}, and θ_{T27} of the second prisms 12b1, 12b2, 12b3, 12b4, 12b5, 12b6, and 12b7 in the sub-regions B21, B22, B23, B24, B25, B26, and B27 are diminishing from the sub-region B21 near the first area B1 to the sub-region B21 distant from the first area B1 (which is the sub-region B27 near the connection part C).

The present embodiment is described with the second area B2 having 7 sub-regions B21, B22, B23, B24, B25, B26, and B27, and each sub-region B21, B22, B23, B24, B25, B26, and B27 is described with just one second prism 12b1, 12b2, 12b3, 12b4, 12b5, 12b6, and 12b7. However, the invention is not limited to the amount of the sub-regions, the amount of the second prisms in each sub-region, or an area of each sub-region thereto.

Referring to FIG. 2C, in another embodiment, the second area may include 4 sub-regions B21, B22, B23, and B24, and the vertex angles θT21, θT22, θT23, and θT24 of the second prisms 12b1, 12b2, 12b3, and 12b4 are substantially equal to each other in each sub-region B21, B22, B23, and B24.

Furthermore, the backlight module 124 of the present embodiment may further include other devices. Hereinafter, FIG. 3 is referred for more detailed description. FIG. 3 is a schematic view of the backlight module 124 and the display panel 122 in FIGS. 1A and 1B. Referring to FIG. 3, the backlight module 124 of the present embodiment further includes a backlight source 20, wherein the horizontal prism sheet 10 is disposed between the backlight source 20 and the display panel 122. In the present embodiment, the backlight source 20, for example, is a side type backlight source, but the invention is not limited thereto. In other embodiments, the backlight source 20 may also be a direct type backlight source.

Furthermore, the backlight source 20 of the present embodiment includes a light guide plate 22 and a light emitting device 24 disposed beside the light guide plate 22. In detail, the light guide plate 22, for example, has a first surface S1, a second surface S2 opposite to the first surface S1, and a light-incident surface S3 connecting the first surface S1 and the second surface S2, wherein the first surface S1 is disposed between the horizontal prism sheet 10 and the second surface S2. The first surface S1 is a light existing surface of the light guide plate 22. In the present embodiment, the light emitting device 24, for example, is disposed beside the light-incident surface S3, and the light emitting device 24 may be a lamp or a light emitting diode.

In addition, the backlight source 20 may further include a reflector 26 disposed on a side of the light guide plate 22 opposite to the horizontal prism sheet 10. Furthermore, the reflector 26, for example, is disposed on the second surface S2, and the light guide plate 22 is disposed between the reflector 26 and the horizontal prism sheet 10. The reflector 26 is suitable for reflecting the light that is transmitted to the reflector 26 to the first surface S1; thus, the chance of the light, which is emitted from the light emitting device 24, being outputted by the backlight module 124 is increased.

Referring to FIGS. 1A, 2A, and 3, the light guide plate 22 and the reflector 26 guide a light L emitted from the light emitting device 24 to the horizontal prism sheet 10. Since the vertex angle θT1 of the first prism 12a in the first area B1 is substantially 90 degrees, when the light L enters the first area B1, the light L is reflected back to the second surface S2 of the light guide plate 22 and transmitted upwardly again through the reflector 26 if the light L incident to a side wall surface SA1 of the first prism 12a with an incident angle of 45 degrees. The light L may be outputted by the backlight module 124 and becomes a backlight of the display panel 122 if the light L incident to the side wall surface SA1 of the first prism 12a with other incident angles. In the present embodiment, the light L passing through the first area B1 is emitted from the first light existing area A1. A light L1 emitted from the first light existing area A1 normal incidents to the eyes of the user; therefore, enough light is provided to the display panel 122 for the user to view the display panel 122 clearly.

On the other hand, since the vertex angle θT2 of the second prism 12b in the second area B2 is smaller than 90 degrees in the present embodiment, part of the light entering the second area B2 may have a chance to be emitted with a larger angle from the second light existing area A2. Thus, an illumination range of a light L2 emitted from the second light existing area A2 is able to cover the being illuminated surface A. By guiding part of the light L2 emitted from the second light existing area A2 to the being illuminated surface A, the user is able to recognize the key to operate in a dark environment, and the operational accuracy and convenience in a dark environment are also improved. Therefore, the present embodiment does not need to dispose an additional backlight source under the base 110 (or the being illuminated surface A). Moreover, since the light emitted from the display 120 is used to irradiate the base instead of using the backlight source under the being illuminated surface A, the electronic device using the horizontal prism sheet 10 of the present embodiment may maintain a low manufacturing cost and power consumption and capable of having a relatively thin base 110.

Referring to FIG. 3, the backlight module 124 of the present embodiment further includes a vertical prism sheet 30, wherein the vertical prism sheet 30 is disposed between the backlight source 20 and the horizontal prism sheet 10. The vertical prism sheet 30 includes a plurality of vertically arranged third prisms 32. Furthermore, each of the first prisms 12a, the second prisms 12b, and the third prisms 32, for example, is a prism pillar. In addition, each of the first prisms 12a and the second prisms 12b extends along a direction substantially parallel to the connection part C of the base 110 and the display 120 (direction X) and arranged along a direction Y substantially perpendicular to the connection part C. On the other hand, each of the third prisms 32 extends along a direction Y substantially perpendicular to the connection part C of the base 110 and the display 120 and arranged along a direction X substantially parallel to the connection part C.

Each of the third prisms 32 also has a vertex angle. In the present embodiment, the vertex angles of each of the third prisms, for example, are 90 degrees, but the invention does not limit the angles of each vertex angle of the third prisms 32. Furthermore, persons skilled in the art may adjust the vertex angle and the base angle of the third prism 32 according to the design requirement of the actual product with reference to the teachings of the previous-mentioned first prism 12a and the second prism 12b.

In addition, the backlight module 124 in the present embodiment further includes a plurality of diffusion plates 42 and 44 in order for the light emitted from the back light module 124 to be more uniform. The diffusion plate 42, for example, is disposed between the light guide plate 22 and the vertical prism sheet 30. The diffusion plate 44, for example, is disposed between the display panel 122 and the horizontal prism sheet 10.

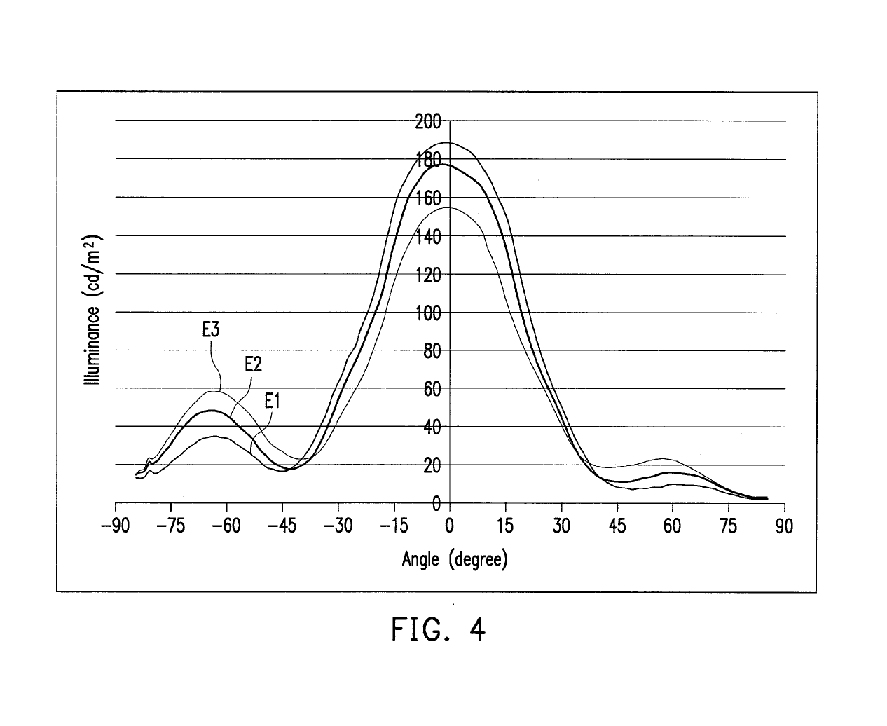

The following uses FIG. 4 to describe the effect of the design of the vertex angle of the first prism on a light emitting angle. FIG. 4 is a relationship diagram of a light emitting angle and a light emitting ratio measured under different vertex angles. Referring to FIG. 4, a horizontal axis represents a light emitting angle, and a vertical axis represents an illumination in FIG. 4. The vertex angles of the three experiments E1, E2, and E3 in FIG. 4 are 90 degrees, 85 degrees, and 80 degrees respectively, and the two base angles that are equal to each other are 45 degrees, 47.5 degrees, and 50 degrees respectively. It can be understood from FIG. 4, under the light with a front view being remain at a certain proportion (which is when the light emitting angle is 0 degree), a decrease of an angle of the vertex angle helps the light to be emitted with a larger angle, wherein a change of the illumination is more obvious when the light emitting angle is 60 degrees. Therefore, the present embodiment enables the user to view both the display and the base in a dark environment by adjusting the vertex angle of the second area in the horizontal prism sheet.

In view of the above, an embodiment of the invention uses a design of the vertex angle of the second area in the horizontal prism sheet to guide part of the light from the second light existing area of the display panel to the being illuminated surface. Under the light with a front view being remain at a certain proportion, the user not only is able to view an image of the display clearly but also is able to view the being illuminated surface of the electronic device. In other words, an embodiment of the invention is capable of allowing the user to recognize the key to operate in a dark environment without disposing an additional backlight module under the being illuminated surface (or base). The operational accuracy and convenience in a dark environment are also improved. Moreover, since the light emitted from the display is used to irradiate the operating base instead of using the backlight source under the base, the electronic device of an embodiment of the invention may maintain a low manufacturing cost and power consumption and is capable of having a relatively thin base.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a display, disposed above a being illuminated surface to illuminate the being illuminated surface and having a first light exiting area and a second light exiting area, wherein illumination of the being illuminated surface contributed by the first light exiting area is smaller than illumination of the being illuminated surface contributed by the second light exiting area.

2. The electronic device according to claim 1, wherein the display further comprises:
a display panel; and
a backlight module, disposed on a side of the display panel and having a horizontal prism sheet, which comprises a first area and a second area, wherein the first area is disposed correspondingly with the first light existing area of the display, and the second area is disposed correspondingly with the second light existing area of the display, wherein the first area has a plurality of first prisms, and the second area has a plurality of second prisms, and wherein a vertex angle of the second prisms is smaller than a vertex angle of the first prisms.

3. The electronic device according to claim 2, wherein the being illuminated surface is a surface of a base, the base is connected to a side of the display, and the second area of the horizontal prism sheet is disposed adjacent to the base.

4. The electronic device according to claim 2, wherein the vertex angle of the second prisms is greater than or equal to 80 degree but smaller than 90 degree.

5. The electronic device according to claim 2, wherein the vertex angle of the second prisms is greater than or equal to 82 degree but smaller than or equal to 88 degree.

6. The electronic device according to claim 2, wherein the vertex angle of the first prisms is substantially equal to 90 degrees.

7. The electronic device according to claim 2, wherein each of the first prisms and the second prisms has two base angles that are substantially equal to each other.

8. The electronic device according to claim 2, wherein an area of the second area occupies ½ to ⅓ of an entire area of the horizontal prism sheet.

9. The electronic device according to claim 2, wherein the second area comprises a plurality of sub-regions, and the vertex angles of the second prisms in the sub-regions diminish from the sub-region near the first area to the sub-region distant from the first area.

10. The electronic device according to claim 1, wherein the backlight module further comprises a backlight source, wherein the horizontal prism sheet is disposed between the backlight source and the display panel.

11. The electronic device according to claim 10, wherein the backlight source comprises:
a light guide plate, and
a light emitting device, disposed beside the light guide plate.

12. The electronic device according to claim 11, wherein the backlight source further comprises a reflector, which is disposed on a side of the light guide plate opposite to the horizontal prism sheet.

13. The electronic device according to claim 10, wherein the backlight module further comprises a vertical prism sheet, which is disposed between the backlight source and the horizontal prism sheet.

14. The electronic device according to claim 13, wherein the vertical prism sheet comprises a plurality of vertically aligned third prisms.
